(19) United States
(12) Patent Application Publication
(10) Pub. No.: US 2022/0298834 A1
(43) Pub. Date: Sep. 22, 2022

(54) CLOSURE LATCH ASSEMBLY WITH CINCH MECHANISM FUNCTIONAL TO RELEASE LATCH MECHANISM

(71) Applicant: MAGNA CLOSURES INC., Newmarket (CA)

(72) Inventor: John DISTEFANO, Newmarket (CA)

(21) Appl. No.: 17/689,785

(22) Filed: Mar. 8, 2022

Related U.S. Application Data
(60) Provisional application No. 63/163,646, filed on Mar. 19, 2021.

(51) Int. Cl. E05B 81/04; E05B 81/14; E05B 81/20; E05B 85/26; E05B 81/68

(52) U.S. Cl. CPC E05B 81/04; E05B 81/14; E05B 81/20; E05B 85/26; E05B 81/68

(57) ABSTRACT

A latch assembly for a motor vehicle closure panel has a ratchet configured for pivoting movement between a primary striker capture position, a secondary striker capture position, an intermediate striker capture position, an over-travel position and an open position. A primary pawl is configured to hold the ratchet in the primary striker capture position. A secondary pawl is configured to hold the ratchet in the secondary striker capture position. An intermediate pawl is configured to hold the ratchet in the intermediate striker capture position. A cinch member is configured to move from a home position to an actuated position, whereupon the ratchet is moved from the primary striker capture position to the over-travel position, whereat the primary pawl disengages the ratchet, and whereupon the cinch member is returned to the home position, whereat the ratchet is moved from the over-travel position to the intermediate striker capture position.

### CROSS-REFERENCE TO RELATED APPLICATION

This application claims the benefit of U.S. Provisional Application Ser. No. 63/163,646, filed Mar. 19, 2021, which is incorporated herein by way of reference in its entirety.

### FIELD

The present disclosure relates to generally to closure panels for motor vehicles, and more particularly, to power actuators for use with power-actuated mechanisms of closure panels.

### BACKGROUND

Motor vehicle closure panels, including various types of hoods, such as used to cover an engine or a frunk (front trunk), typically include latches with power-actuated latch mechanisms to facilitate opening a closing the hood. Such power-actuated mechanisms include a power-operated actuator for moving primary and secondary pawls against respective one-way biases to respective ratchet release positions to allow a ratchet to move from a primary striker capture position, to a secondary striker capture position, and from the secondary capture position to a striker release position, whereat the hood can be opened. Further power-actuated mechanisms include a power-actuated cinch mechanism for returning the ratchet from a secondary striker capture position back to the primary striker capture position.

While such power-actuated mechanisms can function satisfactorily for their intended purpose, to move the hood from a closed position, whereat the ratchet is in the primary striker capture position, to a partially closed position, whereat the ratchet is in the secondary striker capture position, and then to an open position, whereat the ratchet is in the striker release position, advances are desired. For example, being able to move the hood to a positon intermediate the closed position and the partially closed position, such as may be used in a pedestrian protection system, whereat the hood is prevented from moving to the open position, but yet provides increased cushion to a pedestrian impact the hood, whereupon the hood can then be returned to the closed position without concern of inadvertently moving to the open position, is desired.

In view of the above, there remains a need to develop alternative power-actuated mechanisms, including latch mechanisms and cinch mechanisms therefor, which provide advances over known latches and power-actuated latch mechanisms, as well as to provide increased applicability while reducing cost and complexity.

### SUMMARY

This section provides a general summary of the present disclosure and is not a comprehensive disclosure of its full scope or all of its features, aspects and objectives.

In accordance with one aspect of the disclosure, a power operated latch assembly for a closure panel for moving the closure panel between a ratchet 16 configured for pivoting movement between a primary striker capture position, whereat the closure panel is in a fully closed position, a secondary striker capture position, whereat the closure panel is in a partially open position, an intermediate striker capture position between the primary striker capture position and the secondary striker capture position, whereat the closure panel is in a partially closed position, an over-travel position, and an open position, whereat the closure panel can be moved to a fully open position, is provided.

In accordance with another aspect of the disclosure, the power operated latch assembly is actuatable, while the closure panel is in the fully closured position, to move to the intermediate striker capture position solely via a cinching operation.

In accordance with another aspect of the disclosure, the power operated latch assembly includes a ratchet that is biased by a ratchet biasing member toward an open position; a primary pawl that is configured to hold the ratchet in a primary striker capture position, whereat the closure panel is in the fully closed position; a secondary pawl that is configured to hold the ratchet in a secondary striker capture position, whereat the closure panel is in the partially open position; an intermediate pawl that is configured to hold the ratchet in the intermediate striker capture position, whereat the closure panel is in the partially closed position; and a cinch member that is configured to move from a home position to an actuated position, whereupon the ratchet is moved from the primary striker capture position to the over-travel position, whereat the primary pawl disengages the ratchet by moving from the primary ratchet holding position to a ratchet releasing position, and whereupon the cinch member is returned to the home position, whereat the ratchet is moved from the over-travel position to the intermediate striker capture position.

In accordance with another aspect of the disclosure, the primary pawl is biased by a primary pawl spring member to a neutral position, with the primary pawl being biased in a first direction away from the neutral position against the bias imparted by the primary pawl spring member by the ratchet when the ratchet is in the primary striker capture position.

In accordance with another aspect of the disclosure, the primary pawl is biased by the primary pawl spring member to the neutral position when the ratchet is moved to the over-travel position.

In accordance with another aspect of the disclosure, the primary pawl is biased by the ratchet in a second direction opposite the first direction away from the neutral position against the bias imparted by the primary pawl spring member as the cinch member is returned toward the home position.

In accordance with another aspect of the disclosure, the primary pawl has a stop tab biased by a stop tab spring member to a stop position, with the ratchet engaging the stop tab while moving from the primary striker capture position toward the intermediate striker capture position and causing the stop tab to pivot against the bias of the stop tab spring member to a release position, whereat the stop tab disengages the ratchet, whereupon the primary pawl returns to the neutral position under the bias imparted by the primary pawl spring member.

In accordance with another aspect of the disclosure, the primary pawl is biased to the neutral position by the primary pawl spring member when the ratchet is in the intermediate striker capture position.

In accordance with another aspect of the disclosure, the ratchet is urged to move from the intermediate striker capture position to the over-travel position by the cinch member as the cinch member moves from the home position to the actuated position, whereupon the ratchet engages the primary pawl and biases the primary pawl in the first direction away from the neutral position against the bias imparted by the primary pawl spring member to the ratchet hold position.

In accordance with another aspect of the disclosure, the rate of movement of the ratchet from the over-travel position to the intermediate striker capture position can be controlled by the rate of movement of the cinch member from the actuation position to the home position, thereby minimizing the potential for the generation of noise.

In accordance with another aspect of the disclosure, the rate of movement of the ratchet from the over-travel position to the intermediate striker capture position can be controlled by the bias of the ratchet biasing member.

In accordance with another aspect of the disclosure, the ratchet can be prevented from moving to the open position directly from the intermediate striker holding position, thereby assuring the vehicle closure panel is not inadvertently moved from the partially closed position toward the open position.

In accordance with another aspect of the disclosure, a method of releasing a latch assembly to move a closure panel from a closed position to a partially closed position is provided. The method includes receiving a signal to release latch assembly from the fully closed position; actuating and controlling a cinch actuator and moving a ratchet to an over-travel position; returning the cinch actuator and allowing movement of the ratchet toward a striker release position, whereat the closure panel is held in the partially closed position.

In accordance with another aspect of the disclosure, the method can further include controlling the cinch actuator to control the speed of rotation of the ratchet as the ratchet moves toward the striker release position.

In accordance with another aspect of the disclosure, the method further includes moving the ratchet to an intermediate striker capture position located between the primary striker capture position and secondary striker capture position and holding the ratchet in the intermediate striker capture position upon moving a cinch lever from an actuated position back to a home position.

In accordance with another aspect of the disclosure, a method of releasing a latch assembly to move a closure panel from a closed position to a partially closed position includes: receiving a signal to release latch assembly from the fully closed position; controlling power release to release latch assembly; controlling a cinch actuator to control the speed of rotation of ratchet to move toward a striker release position; and returning the cinch actuator at a position before the secondary striker capture position.

### BRIEF DESCRIPTION OF THE DRAWINGS

Other features, aspects and advantages of the present disclosure will be readily appreciated, as the same becomes better understood by reference to the following detailed description when considered in connection with the accompanying drawings wherein:

FIG. 1 is a side view of a vehicle including a power actuatable latch assembly having a cinch actuation mechanism for moving a vehicular closure panel from a fully closed position to an intermediate, partially closed position in accordance with an aspect of the disclosure, and for facilitating movement of the vehicular closure panel to a partially open position and to a fully open position;

FIG. 2 is a side view of the power actuatable latch assembly associated with the vehicle shown in FIG. 1;

FIG. 2A is a side view of the power actuatable latch assembly of FIG. 2 with a cinch lever, an intermediate pawl and cinch and release actuators removed therefrom for clarity purposes only;

FIG. 3 is a view similar to FIG. 2A with a ratchet of the power actuatable latch assembly shown moved to an intermediate striker capture position, whereat the vehicular closure panel is moved to the intermediate, partially closed position;

FIG. 4 is a view similar to FIG. 2A with the ratchet of the power actuatable latch assembly shown moved to a secondary striker capture position, whereat the vehicular closure panel is moved to the partially open position;

FIG. 5 is a view similar to FIG. 2A with the ratchet of the power actuatable latch assembly shown moved to a striker release position, whereat the vehicular closure panel can be moved to the fully open position;

FIG. 6 is a view similar to FIG. 2 illustrating a primary pawl of the power actuatable latch assembly holding the ratchet in the primary striker capture position with an intermediate pawl shown disengaged from the ratchet;

FIG. 7 is a view similar to FIG. 6 illustrating the ratchet being biased by a cinch member (not illustrated) from the primary striker capture position toward an over-travel position to release the ratchet from being held by the primary pawl in the primary striker capture position;

FIG. 8 is a view similar to FIG. 7 illustrating the primary pawl being biased by a primary pawl biasing member toward a neutral position;

FIG. 9 is a view similar to FIG. 8 illustrating the primary pawl returned to the neutral position by the primary pawl biasing member;

FIG. 10 is a view similar to FIG. 9 illustrating the ratchet being biased from the over-travel position toward a striker release position and coming into initial engagement with the primary pawl while in the neutral position;

FIG. 11 is a view similar to FIG. 10 illustrating the ratchet continuing to be biased toward the striker release position and biasing the primary pawl away from the neutral position;

FIG. 12 is a view similar to FIG. 11 illustrating the ratchet continuing to be biased toward the striker release position and continuing to bias the primary pawl away from the neutral position;

FIG. 13 is a view similar to FIG. 12 illustrating the ratchet continuing to be biased toward the striker release position and continuing to bias the primary pawl away from the neutral position while disengaging a main body of the primary pawl and coming into engagement with a stop tab of the primary pawl;

FIG. 14 is a view similar to FIG. 13 illustrating the ratchet continuing to be biased toward the striker release position and causing the stop tab to pivot against a bias of a stop tab biasing member;

FIG. 15 is a view similar to FIG. 14 illustrating the ratchet bypassing the stop tab and coming into initial engagement with the intermediate pawl;

FIG. 16 is a view similar to FIG. 15 illustrating the ratchet engaged with the intermediate pawl in the intermediate striker engagement position with the primary pawl returned to the neutral position under the bias of the primary pawl biasing member;

FIG. 17 is a view similar to FIG. 16 illustrating the ratchet being biased toward the over-travel position by the cinch member (not illustrated);

FIG. 18 is a view similar to FIG. 17 illustrating the ratchet continuing to be biased toward the over-travel position and causing the primary pawl to move away from the neutral position against the bias of the primary pawl biasing member;

FIG. 19 is a view similar to FIG. 18 illustrating the ratchet continuing to be biased toward the over-travel position and causing the primary pawl to continue to move away from the neutral position against the bias of the primary pawl biasing member;

FIG. 20 is a view similar to FIG. 19 illustrating the ratchet continuing to be biased toward the over-travel position and causing the primary pawl to continue move away from the neutral position against the bias of the primary pawl biasing member;

FIG. 21 is a view similar to FIG. 20 illustrating the ratchet continuing to be biased toward the over-travel position with the primary pawl being released for movement back toward the neutral position under the bias of the primary pawl biasing member;

FIG. 22 is a view similar to FIG. 21 illustrating the ratchet biased to the over-travel position with a leg of the ratchet being sensed by a sensor and the stop tab of the primary pawl stopping movement of the primary pawl back toward the neutral position;

FIG. 23 is a view similar to FIG. 22 illustrating the ratchet being biased toward the striker release position into engagement with the main body of the primary pawl by the ratchet biasing member with the cinch member (not illustrated) being returned to the home position;

FIG. 24 is a view similar to FIG. 23 illustrating the ratchet biased to the primary striker capture position by the ratchet biasing member with the primary pawl shown in the ratchet holding position and with the cinch member (not illustrated) returned to the home position;

FIG. 25 is a flow chart illustrating a method of releasing a latch assembly to move a closure panel from a closed position to a partially closed position in accordance with an aspect of the disclosure; and

FIG. 26 is a flow chart illustrating another method of releasing a latch assembly to move a closure panel from a closed position to a partially closed position in accordance with another aspect of the disclosure.

### DETAILED DESCRIPTION OF EXAMPLE EMBODIMENTS

In general, example embodiments of power actuators having a dual cable actuating mechanism constructed in accordance with the teachings of the present disclosure and mechanically actuatable components operably coupled thereto for selective and independent mechanical actuation via cables of the dual cable actuating mechanism will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom,” and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

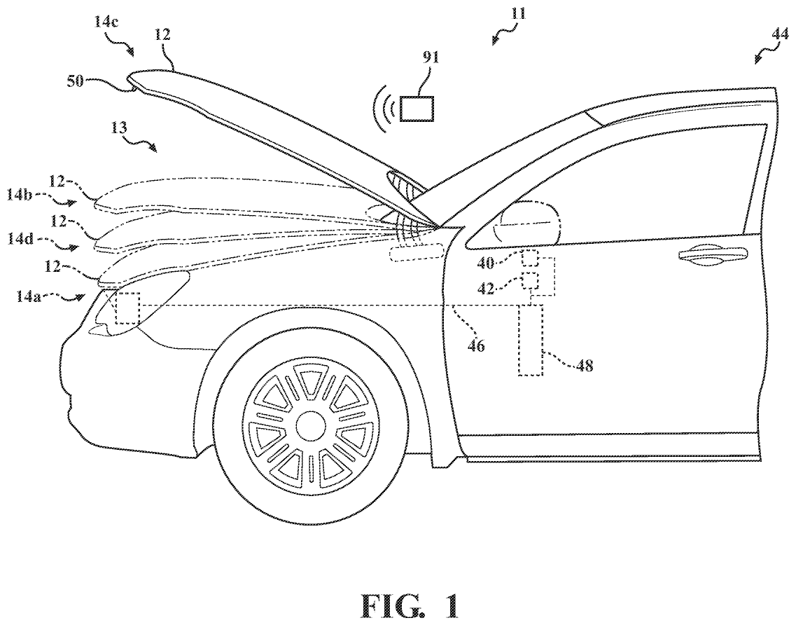

Reference is made to FIG. 1, which shows a motor vehicle 11 that has a power-operated latch assembly, referred to hereafter as latch assembly 10, constructed in accordance with one aspect of the disclosure. Latch assembly 10 is shown as being associated with a closure panel 12, such as a front hood which can be used to cover an engine compartment or a frunk, by way of example and without limitation, and referred to hereafter as compartment 13. A frunk is a forward compartment of the vehicle normally occupied by an internal combustion engine, however in the configuration where an engine is not provided within such compartment (for example, where the engine is provided in the rear of the vehicle, or in the configuration of an electrical vehicle where the electric motor may be provide at other locations or below the compartment), such a compartment is converted for use as storage for items such as luggage, groceries, and the like normally stored in a rear trunk requiring higher frequency access by a user as compared to the lower access frequency for servicing an engine). It is to be understood that latch assembly 10 could be used for other closure panels, as desired, such as, for example, rear trunk lids, rear hatches, and passenger doors. Latch assembly 10 is operable to position the closure panel 12 in multiple positions, depending on the desired function, including three commonly known closure panel positions, including a fully closed position 14a, typically associated with a normal driving position, a partially open position 14b, typically associated with a first release of the latch assembly 10 prior to fully opening the closure panel 12, and a fully open position 14c, typically associate with full release of the latch assembly 10 to allow full access to the compartment 13. Additionally, latch assembly 10 is operable to position the closure panel 12 in an intermediate closed position 14d between the fully closed position and the partially open position, such as may be desired to provide pedestrian protection to a pedestrian impacting closure panel 12, by way of example and without limitation, thereby providing a source of cushion to the pedestrian via the slightly raised closure panel 12. It is to be understood that motor vehicle 11 is fully operable at any operational speed of the motor vehicle 11 while closure panel 12 is in the intermediate position 14d.

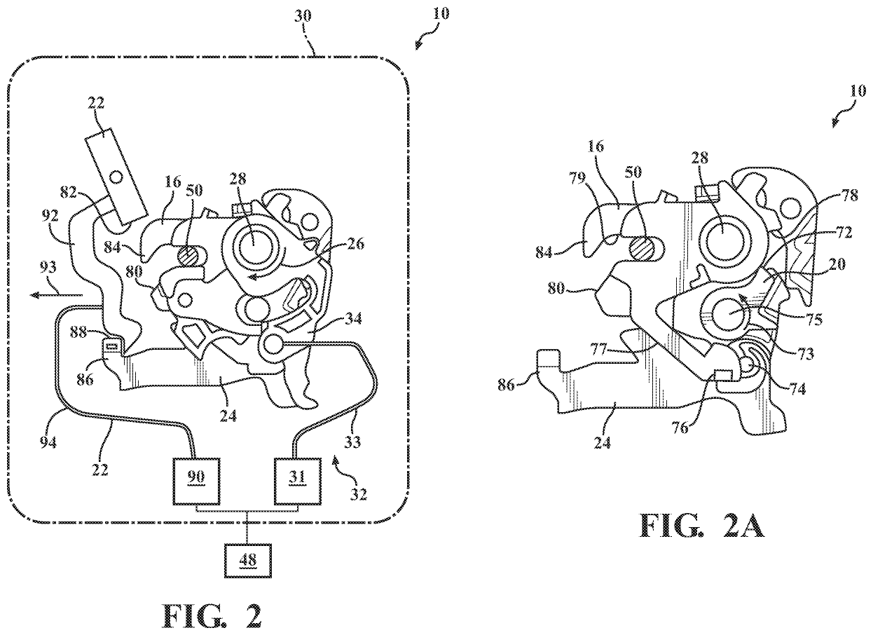

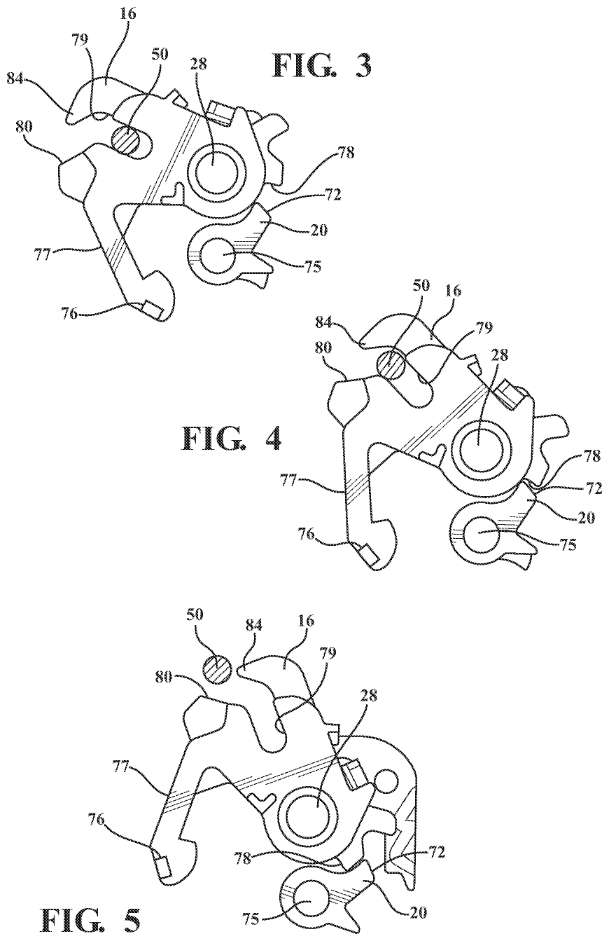

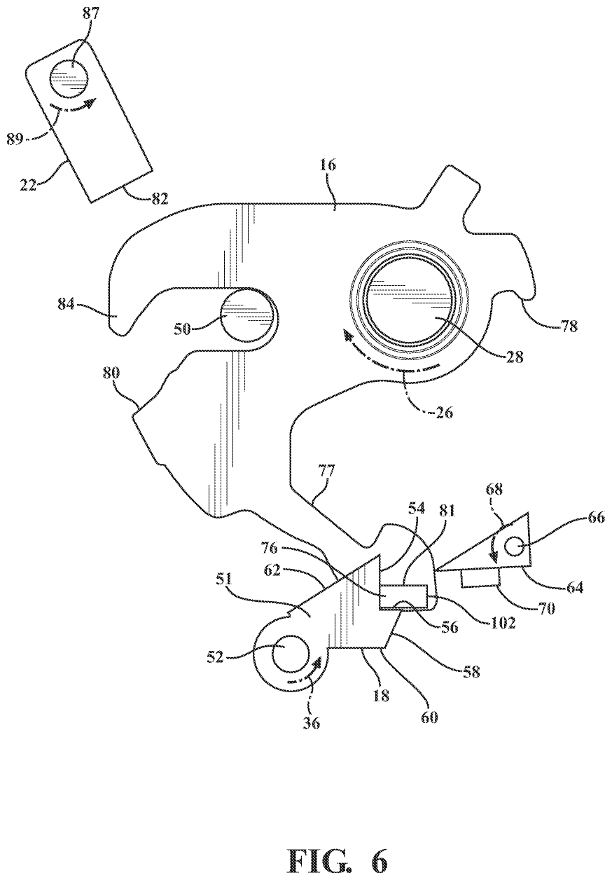

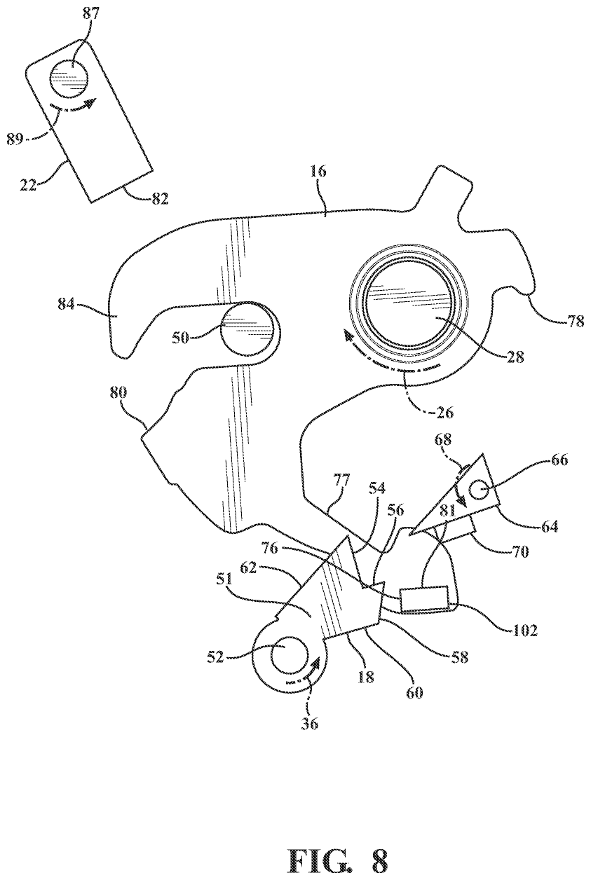

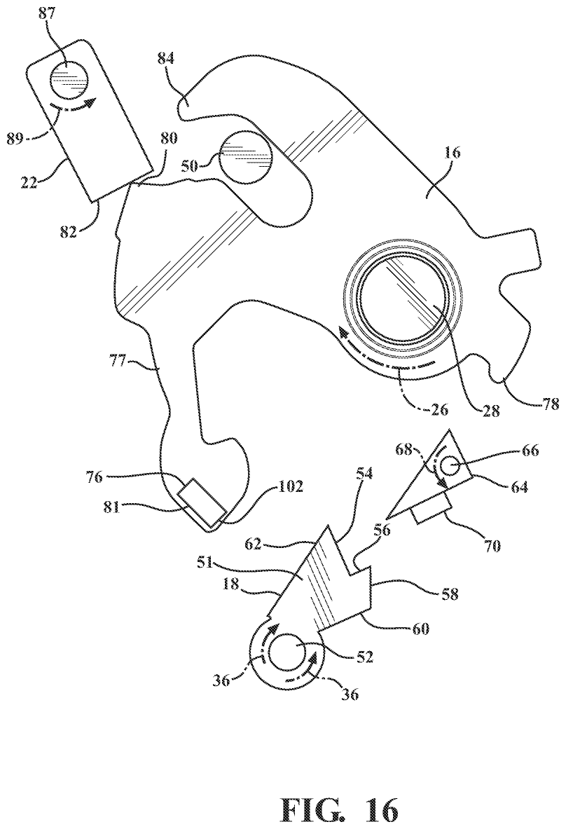

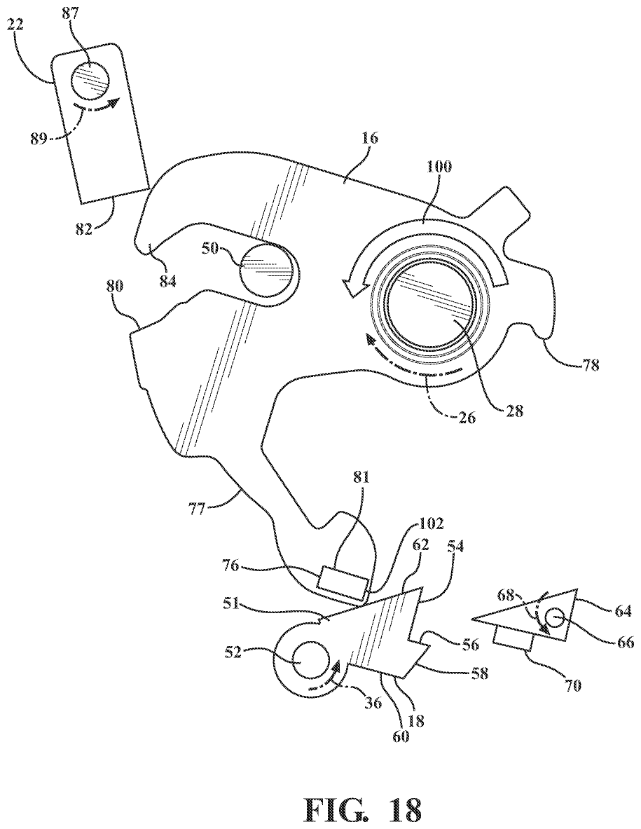

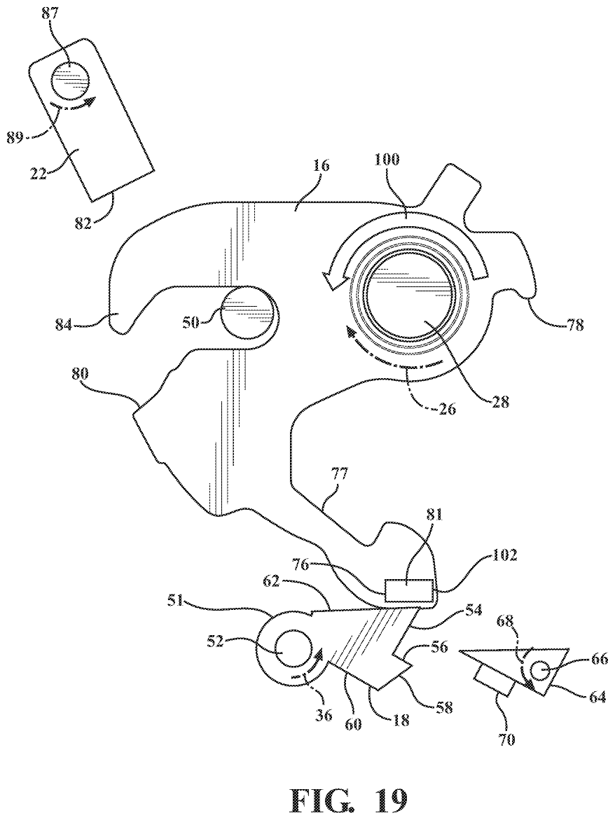

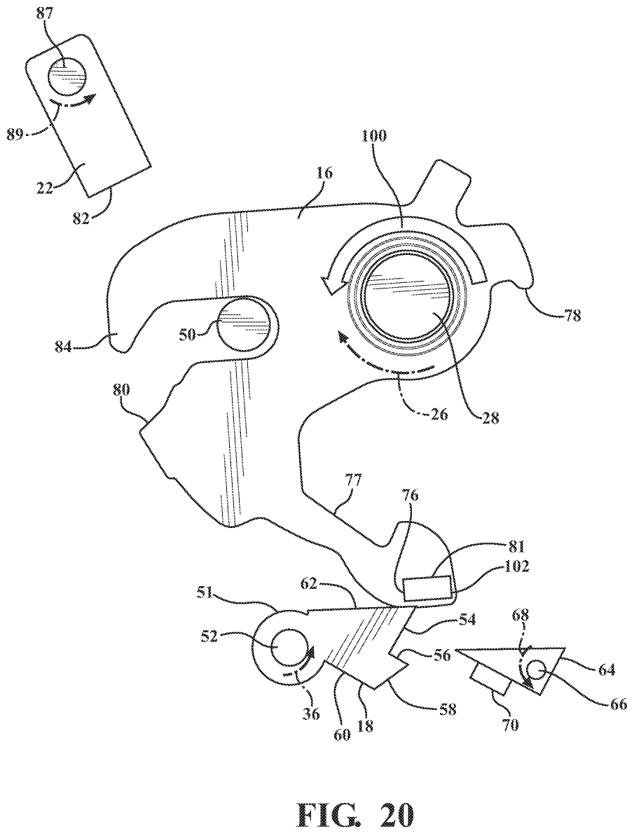

Referring to FIGS. 2 through 5, in accordance with one aspect, the latch assembly 10 can include a ratchet 16, a primary pawl 18 (FIGS. 6-23), a secondary pawl 20, an intermediate pawl 22 (FIGS. 6-23), and a coupling link, also referred to as coupling lever 24. The ratchet 16 is movable between a primary closed position, also referred to as primary striker capture position (FIGS. 2-2A, 6, and 24), a secondary closed position, also referred to as secondary striker capture position (FIG. 4), an intermediate closed position, also referred to as intermediate striker capture position (FIGS. 3 and 16), an over-travel position (FIGS. 8, 9, 21 and 22), and an open position (FIG. 5) in response to selective coordinated movement of the primary and secondary pawls 18, 20, as discussed further hereafter. The ratchet 16 is biased toward the open position, shown as a clockwise direction in FIGS. 6-24, by a ratchet biasing member 26, such as a spring member, shown schematically at arrow 26. The pivotal movement of the ratchet 16 may take place about a pin 28 that can be mounted to a housing, shown in FIG. 2 schematically in phantom at 30. In the primary, intermediate and secondary closed positions, the ratchet 16 prevents the withdrawal of a striker 50 that is mounted to the vehicle hood 12. When in the primary closed position, the ratchet 16 holds the striker 50 relatively deeper within a slot, commonly referred to fishmouth (not shown, but well-known in the art), of the housing 30, whereat the hood 12 is in a fully closed state, as compared to when ratchet 16 is in the secondary closed position, whereat the hood 12 is in a partially open state, and when ratchet 16 is in the intermediate closed position, whereat the hood 12 is in a partially closed state, but prevented from being moved to the fully open position by ratchet 16. Thus, in the primary closed position the ratchet 16 holds the striker 50 at a first depth in the fishmouth, and in the secondary closed position the ratchet 16 holds the striker 50 at a second depth in the fishmouth of the housing 46, wherein the first depth is greater than the second depth, and in the intermediate closed position the ratchet 16 holds the striker 50 at a third depth in the fishmouth of the housing 46, wherein the third depth is less than the first depth and greater than the second depth.

Primary pawl 18 is configured to hold the ratchet 16 in the primary closed position while in a primary ratchet holding position, secondary pawl 20 is configured to hold the ratchet 16 in the secondary closed position while in a secondary ratchet holding position, and the intermediate pawl 22 is configured to hold the ratchet 16 in the intermediate closed position while in an intermediate holding position, also referred to as intermediate striker capture position.

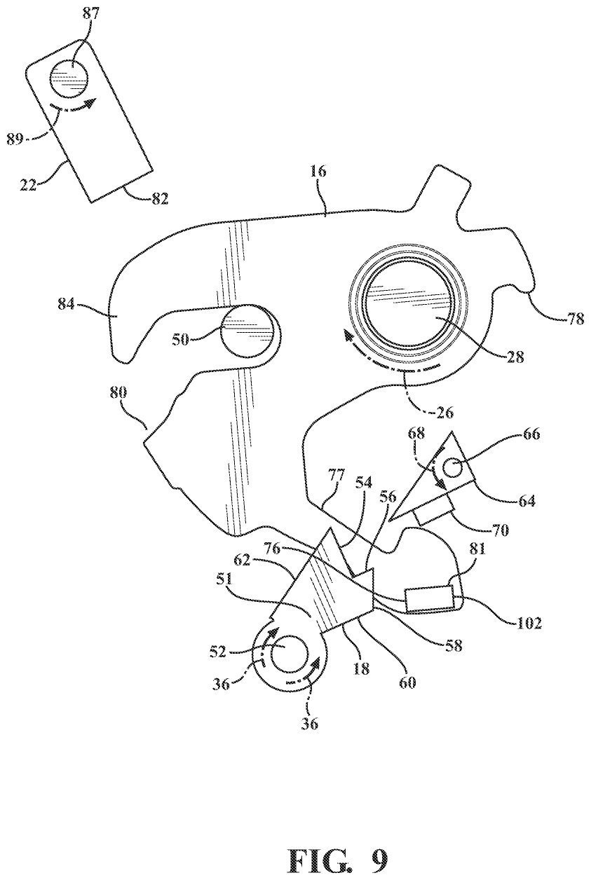

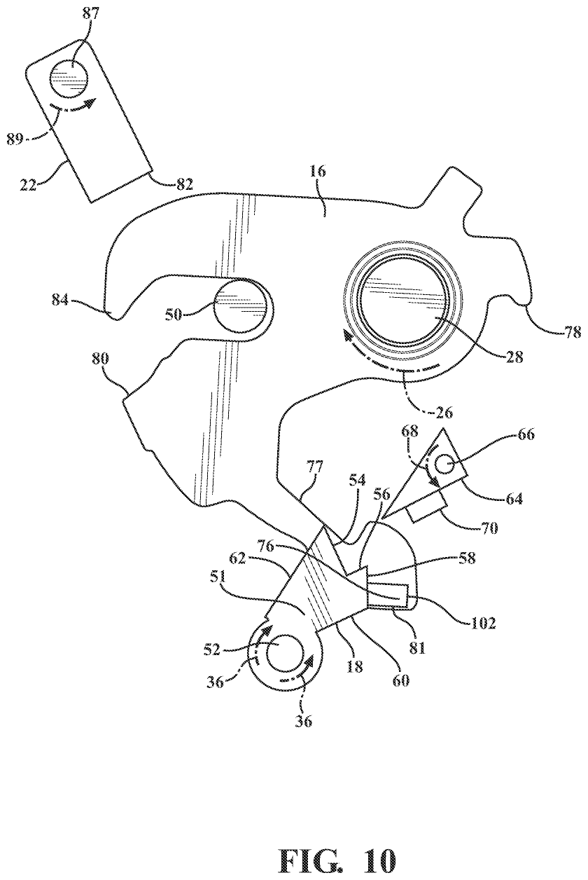

A cinch member, also referred to as cinch lever 34, is driven by a cinch actuator, also referred to as cinch motor 31, of a cinch mechanism, also referred to as cinch system 32, wherein cinch lever 34 is configured to move from a home position to an actuated position. As cinch lever 34 is being driven to the actuated position, such as via a cinch cable 33 driven by cinch motor 31, the ratchet 16 is moved from the primary striker capture position to the over-travel position, whereat the primary pawl 18 disengages the ratchet 16 by moving from the primary ratchet holding position to a ratchet releasing position. Upon being disengaged from the ratchet 16, the primary pawl 18 is biased by a primary pawl biasing member 36, such as a spring member shown schematically at arrow 36, to a neutral position (FIGS. 9 and 10). Cinch lever 34 then moves via cinch cable 33 being driven by cinch motor 31 from the actuated position back to the home position, whereat the ratchet 16 is moved from the over-travel position to the intermediate striker capture position. While ratchet 16 is in the intermediate striker capture position, intermediate pawl 22 prevents hood 12 from opening beyond the partially closed position toward the open position, and thus, motor vehicle 11 is able to be driven at normal operating speeds, as desired. To return hood 12 to the fully closed position, cinch lever 34 can be cinched again to return ratchet 16 to the primary striker capture position, as discussed in more detail hereafter.

A first actuation device 40, such as a button, lever, rotatable knob or otherwise, and a separate second actuation device 42, such as a button, lever, rotatable knob or otherwise, located within a passenger compartment, also referred to as vehicle cabin 44, of motor vehicle 11 are in operable communication with the cinch lever 34 and the primary intermediate pawl 22, respectively, via an electrical member 46. A controller 48 may be provided as part of the latch assembly 10 or as a standalone controller unit, as shown, in which controller 48 may be electrically coupled to the latch assembly 10 via electrical member 46, and first and second actuation devices 40, 42 may be electrically coupled to the latch assembly 10 via controller 48, by way of example and without limitation. Controller 48 may be, for example, integrated into a Body Control Module (BCM) of the vehicle 11 or provided as a separate controller 48′, if desired.

The primary pawl 18 has a main body 51 supported for pivotal movement relative to housing 30 by a pawl pin, also referred to as first pin or pin 52. Primary pawl 18 has a primary locking surface 54; a stop surface 56 inclined relative to the primary locking surface 54, shown as extending in generally transverse relation from the primary locking surface 54, by way of example and without limitation; a primary drive surface 58 inclined relative to the stop surface 56, shown as extending in reverse, re-entrant fashion from the stop surface 54 such that primary drive surface 58 extends beneath the stop surface 56; a secondary drive surface 60 inclined relative to the primary drive surface 58, shown as extending from the primary drive surface 58 toward pin 52, and a return engagement surface 62 inclined relative to the primary locking surface 54, shown as extending in reverse fashion from the primary locking surface 54 and forming an external angle of greater than 270 degrees with the primary locking surface 54, by way of example and without limitation.

Primary pawl 18 further includes a pawl stop tab, also referred to as stop member or stop tab 64, supported by main body 51 for pivotal movement relative thereto by a stop tab pin, also referred to as second pin or pin 66. Stop tab 64 is biased in a counter clockwise direction, as viewed in FIGS. 6-24, by a stop tab biasing member 68, such as a spring member, into engagement with a hard stop, also referred to as stop tab 70, extending in fixed relation from main body 51. Tab 70 can be formed as a monolithic piece of material with main body 51 or as a separated piece of material that is subsequently fixed to main body 51, as desired.

Secondary pawl 42 has a secondary locking surface 72 biased into abutment with ratchet 16 via any suitable secondary pawl biasing member, such as a spring member, shown schematically in FIG. A at arrow 73, by way of example and without limitation. A pin 74 extends laterally outwardly from a generally planar surface of the secondary pawl 20, wherein pin 74 supports coupling lever 24 for pivotal movement thereon. Pivotal movement of the secondary pawl 20 may take place about a pin 75 that can be mounted to the housing 30.

Ratchet 16 has a primary lock surface 76, shown as being formed by a tab 81 extending laterally outwardly from a leg 77 of ratchet 16, configured for selective releasably locked engagement with primary locking surface 54 of primary pawl 18, a secondary lock surface 78 configured for selective releasably locked engagement with secondary locking surface 72 of secondary pawl 20, and an intermediate lock surface 80 configured for selective releasably locked engagement with an intermediate locking surface 82 of intermediate pawl 22. Ratchet 16 has a slot 79 configured for receipt of striker 50 therein while in the primary, intermediate and secondary closed positions. To facilitate maintaining the ratchet 16 in the secondary closed position, until desired to move ratchet 16 to the fully open position, a hook-shaped nose 84, opposite intermediate locking surface 80, is provided at an exit region of the slot 79. The leg 77 extends away from slot 79 into generally underlying relation with ratchet pin 28. Let 77 locates primary lock surface 76 for selective locking abutment with primary locking surface 54 of primary pawl 18 to selectively maintain latch assembly 10 in its fully latched state with ratchet 16 in its primary striker capture position.

The coupling lever 24 is pivotably mounted to the secondary pawl 20 via pin 74. Coupling lever 24 extends from pin 74 to a generally hook-shaped portion 86 that terminates at a free end 88. In use, in a normal release condition, as discussed in more detail hereafter, selective actuation of a release actuation device, also referred to as release motor 90 via selective actuation of second actuation device 42 or via a remote device, such as a key fob 91 configured in operable communication with controller/BCM 48, causes intermediate pawl 22 to pivot clockwise about a pin 87 against a bias imparted by an intermediate pawl biasing member 89 under a bias imparted on a drive arm 92 fixed to intermediate pawl 22 in a direction of arrow 93, which is acted on by a release cable 94, as viewed in FIG. 2, such that ratchet 16 can be moved to its secondary striker capture position, whereat secondary locking surface 72 of secondary pawl 20 is brought into engagement with secondary lock surface 78 of ratchet 16. Then, upon performing a second actuation of release motor 90, secondary pawl 20 is caused to be moved to its ratchet release position under a bias imparted by coupling link 24, whereat ratchet 16 can move under the bias of ratchet biasing member 26 to its striker release position.

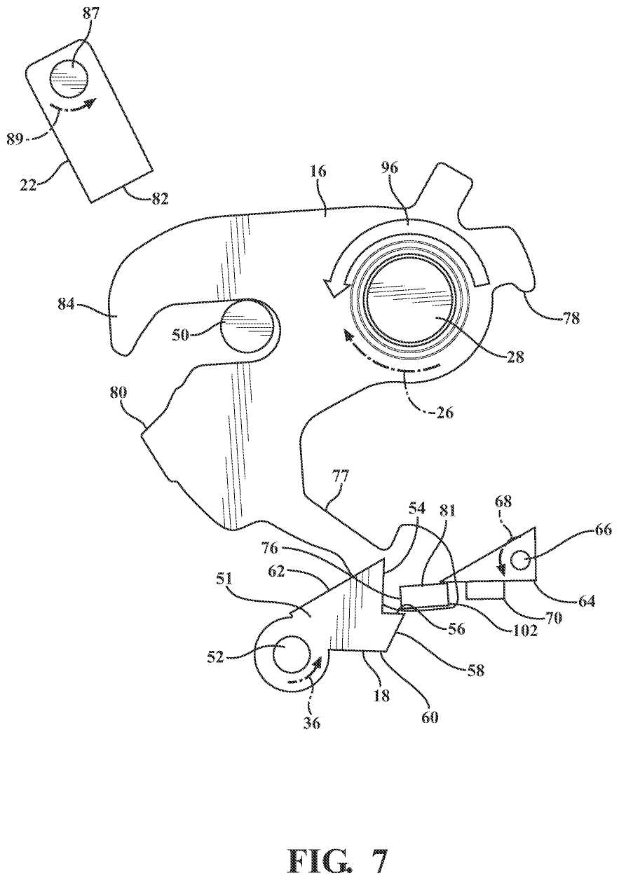

In use, with latch assembly 10 in its fully latched, closed position, whereat ratchet 16 is in its primary striker capture position (FIG. 6), latch assembly 10 can be moved to the intermediate closed position, when desired, simply by actuating the first actuation device 40, such as by an occupant in the vehicle cabin 44. Actuation of first actuation device 40 causes cinch motor 31 to be actuated and move cinch cable 33, thereby causing cause cinch lever 34 to impart a bias on ratchet 16 to rotate ratchet 16 in the direction of arrow 96 (FIG. 7) toward the over-travel position against the bias of ratchet biasing member 26. As ratchet 16 begins to rotate toward the over-travel position, primary lock surface 76 is moved out from engagement with primary locking surface 54 and stop surface 56 of primary pawl 18 (FIG. 7), whereupon primary ratchet 18 moves under the bias of primary pawl biasing member 36 to the neutral position (FIG. 9).

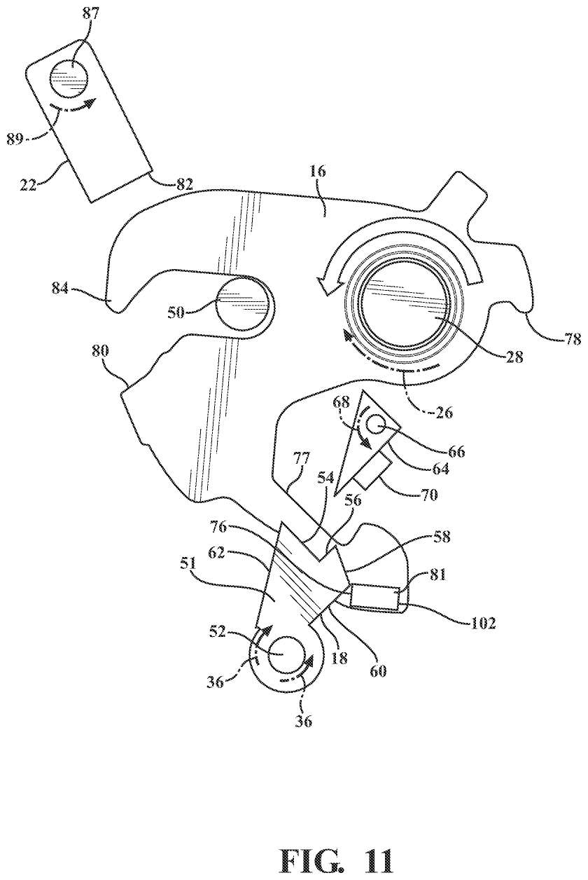

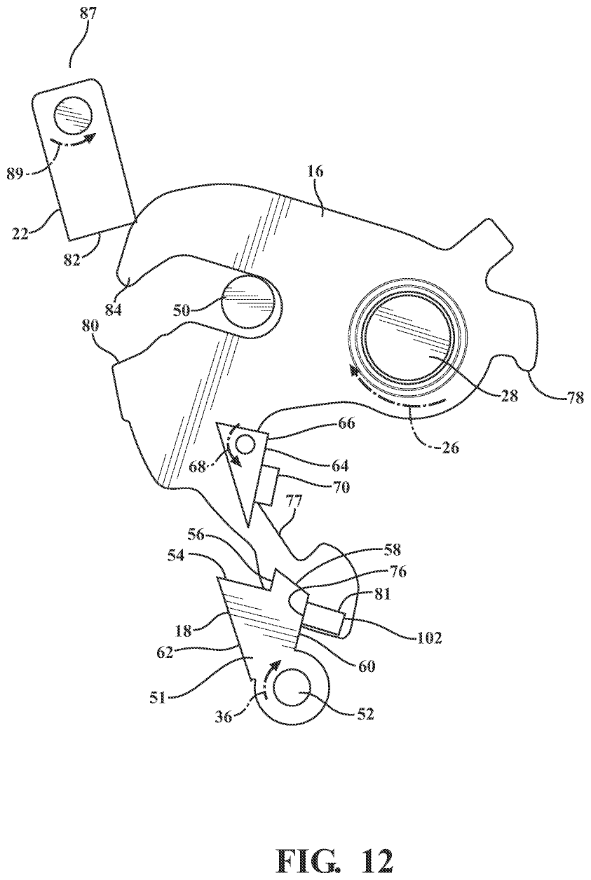

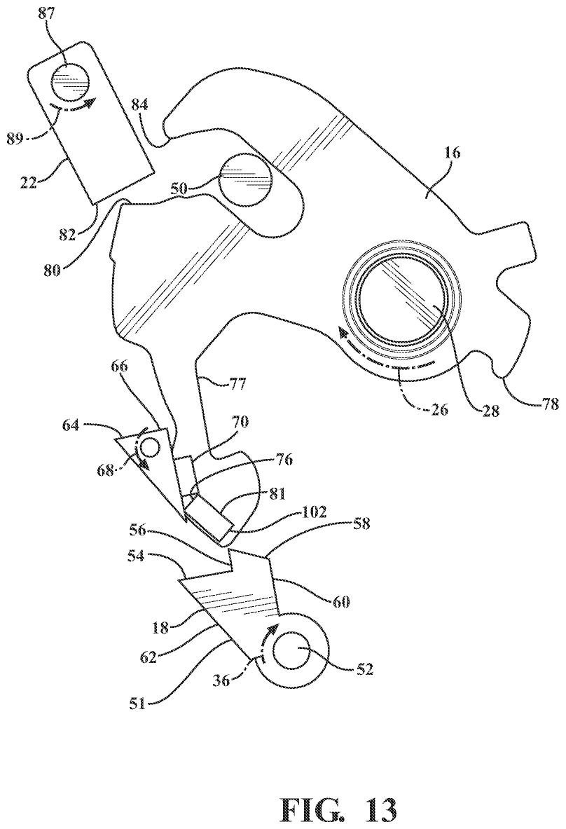

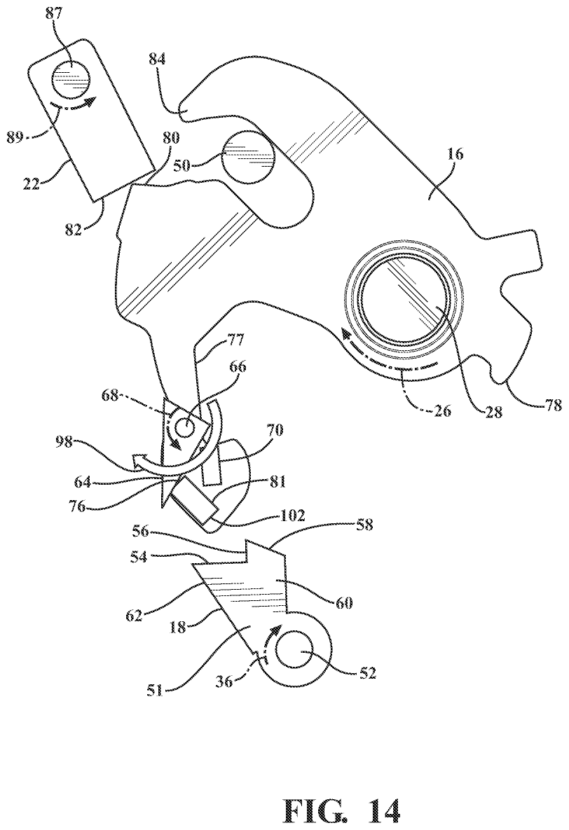

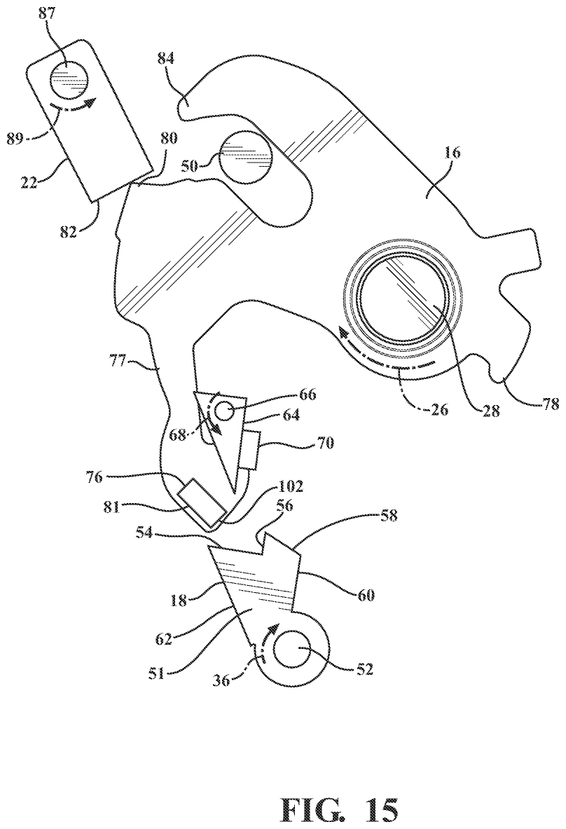

Upon ratchet 16 being moved via cinch lever 34 to the over-travel position and releasing primary pawl 18, cinch motor 31 can be reversed, whereupon ratchet 16 is caused to move clockwise, as viewed in FIGS. 10-16. In FIGS. 10 and 11, primary lock surface 76 is shown being brought into engagement with primary drive surface 54 of primary pawl 18, thereby causing primary pawl 18 to be rotated counterclockwise against the bias of primary pawl biasing member 36. In FIG. 12, primary lock surface 76 is shown being brought into engagement with secondary drive surface 60, causing primary pawl 18 to be rotated counterclockwise further against the bias of primary pawl biasing member 36. In FIG. 13, primary lock surface 76 is shown out of engagement with main body 51 of primary pawl 18, such that primary pawl is able to rotate under the bias of primary pawl biasing member 36 in the clockwise direction. In FIG. 14, primary lock surface 76 is shown being brought into engagement with stop tab 64 as primary pawl 18 is biased in the clockwise direction and as ratchet 16 continues to move in the clockwise direction. The bias imparted on stop tab 64 by stop tab biasing member 68 is overcome, thereby allowing stop tab 64 to rotate clockwise against the bias of stop tab biasing member 68, as indicated by arrow 98 (FIG. 14). Continued rotation of ratchet 16 and primary pawl 18 in the clockwise direction allow primary lock surface 76 to bypass stop tab 64 (FIG. 15), whereupon primary pawl 18 returns to its neutral position as ratchet 16 is moved into the intermediate striker capture position (FIG. 16). It is to be understood that the rotational speed of ratchet 16 from the over-travel position (FIG. 7) to the intermediate striker capture position (FIG. 16) can be controlled via controlling the rotation speed of cinch lever 34, if desired, thereby allowing cinch system 32 to act as a control brake to minimize noise from impact of intermediate lock surface 80 with intermediate locking surface 82 of intermediate pawl 22. Otherwise, it is contemplated that the rotational speed of ratchet 16 can be provided via ratchet biasing member 26.

When in the intermediate striker capture position, hood 12 is prevented from opening by intermediate locking surface 82 of intermediate pawl 22 providing a hard stop against intermediate lock surface 80 of ratchet 16. In accordance with an aspect herein, latch assembly 10 can be prevented from being released directly from the partially closed position to the open position, thereby providing assurance that the hood 12 will not be inadvertently released to its open position. Accordingly, the ratchet 16 can be required to be re-cinched via the cinch system 32 to its primary striker capture position prior to being moved to the striker release position, whereat hood 12 can be moved to the open position.

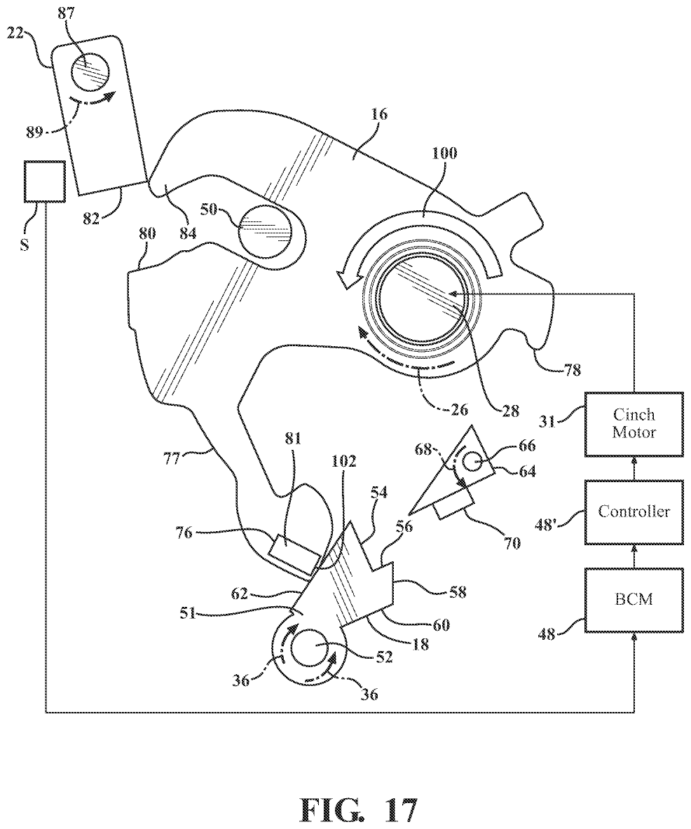

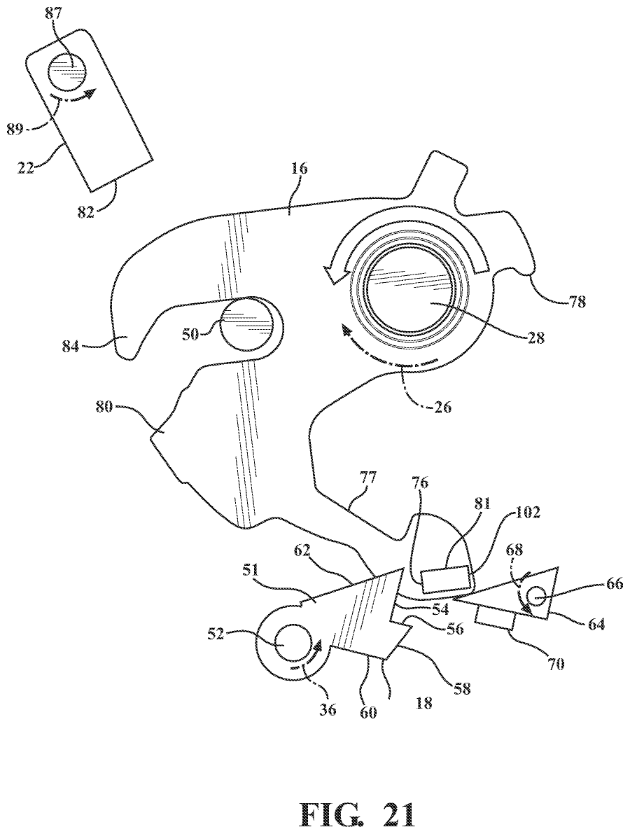

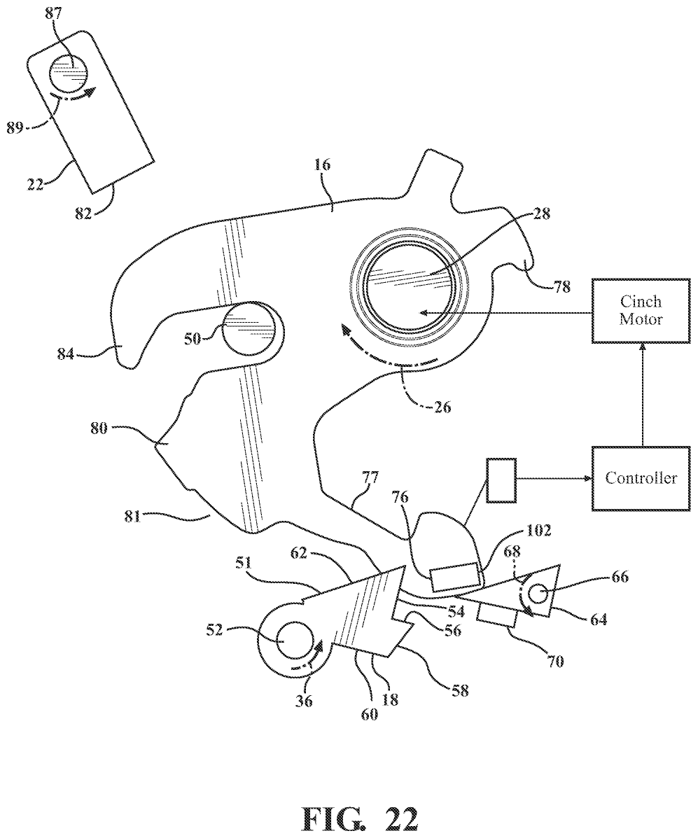

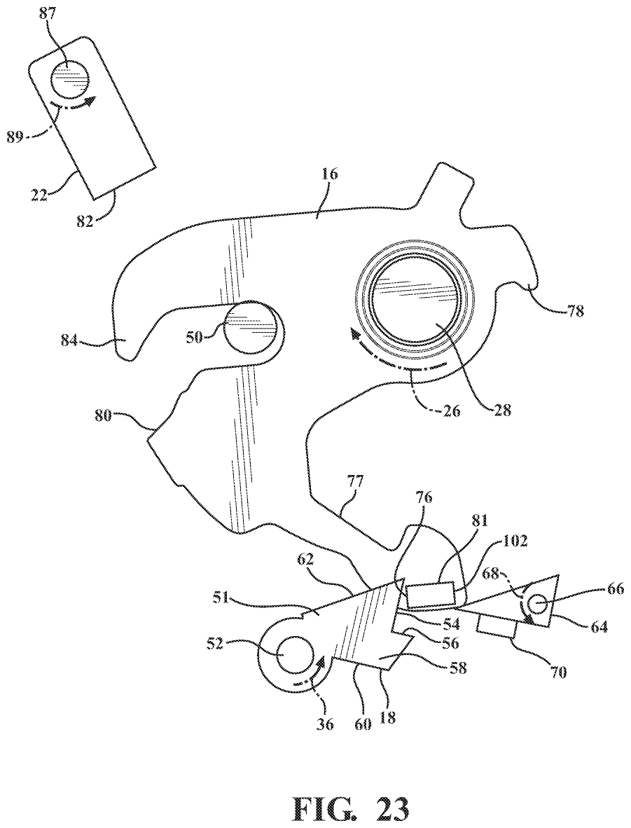

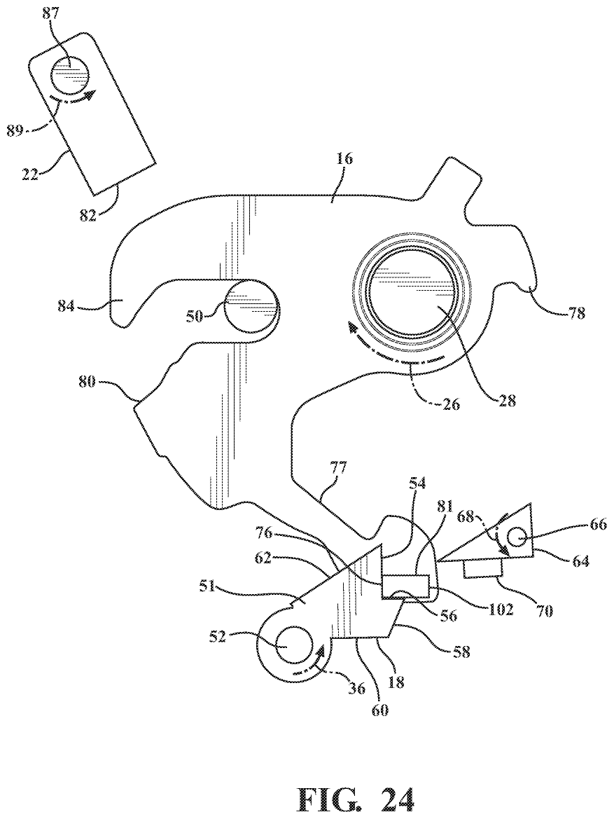

During a re-cinching operation, first actuation device 40 can be selectively actuated, as desired, to actuate cinch motor 31 and cause cinch lever 34 to rotate ratchet 16 in a counterclockwise direction, as indicated by arrow 100 in FIGS. 17-21. As ratchet 16 rotates in the counterclockwise direction, an abutment surface 102 of the tab 81 opposite lock surface 76 engages return engagement surface 62 of primary pawl 18, thereby causing primary pawl 18 to be rotated against the bias imparted by primary pawl biasing member 36 (FIGS. 17-20). When ratchet 16 is moved to the over-travel position, tab 81 moves beyond main body 51 of primary pawl 18 (FIG. 21) and comes into engagement with stop tab 64 which is prevented from rotating relative to main body 51 by stop tab 70 fixed to main body 51 (FIG. 22). When in the over-travel position, arm 77 of ratchet 16 can be trigger a sensor or switch 104 indicating the position of ratchet 16 to controller/BCM 48, whereupon cinch motor lever 34 can be signaled to reverse direction and return cinch lever 34 to it home position. As cinch lever 34 returns to the home position, ratchet 16 is returned to the primary striker capture position, whereupon primary lock surface 76 of ratchet 16 is brought into engagement with primary locking surface 54 of the main body 51 of primary pawl 18 (FIG. 23), whereupon ratchet 16 is ultimately returned to the primary striker capture position (FIG. 24).

In view of the above, it is to be recognized that latch assembly 10 is operable in two scenarios, the first being when the hood 12 is intended to be moved to the partially closed position 14d, and the second being when the hood 12 is desired to be moved to one of the partially open position 14b or the fully open position 14c (FIG. 1). In the first scenario, when the hood 12 is intended to be moved to the partially closed position 14d, only the cinch system 32 and cinch motor 31 thereof need to be actuated. In the second scenario, both the cinch system 32 and cinch motor 31 thereof and the release motor 90 need to be actuated. To move the hood 12 to one of the partially open position 14b or the fully open position 14c, the ratchet 16 must first be cinched to the over-travel position by the cinch motor 31, and then, either simultaneously or in sequence, the release motor 90 must be actuated to cause release of the intermediate pawl 22 to allow the ratchet 16 to bypass the intermediated striker capture position to move to the secondary striker capture position, and the release of secondary pawl 20 to allow the ratchet 16 to move to the striker release position. Whether simultaneous or in sequence, the coordinated actuation can be controlled via controller/BCM 48.

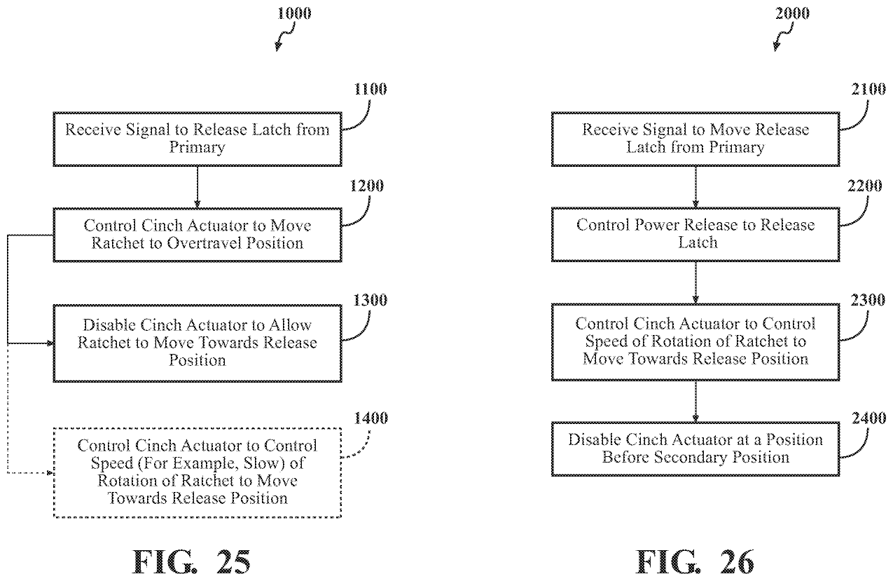

As shown in FIG. 25, a method 1000 of releasing a latch assembly 10 to move a closure panel 12 from a closed position 14a to a partially closed position 14d is shown. The method 1000 includes a step 1100 of receiving a signal to release latch assembly 10 from the fully closed position (also referred to as primary latch position). In step 1100, the signal can be sent via key fob 91 or via first actuation device 40, by way of example and without limitation. The method 1000 further includes a step 1200 of actuating and controlling a cinch actuator 31 and moving a ratchet 16 to an over-travel position. Further, a step 1300 of returning (disabling) the cinch actuator 31 and allowing (promoting) movement of the ratchet 16 to move toward a striker release position. The step 1300 of allowing movement of the ratchet 16 to move toward a striker release position can include releasably locking the ratchet 16 in an intermediate striker capture position between a primary striker capture position and a secondary striker capture position. The method 1000 can further include a step 1400 of controlling the cinch actuator 31 to control the speed of rotation of the ratchet 16 as the ratchet 16 moves toward the release position.

As shown in FIG. 26, a method 2000 of releasing a latch assembly 10 to move a closure panel 12 from a closed position 14a to a partially closed position 14d is shown. The method 2000 includes a step 2100 of receiving a signal to release latch assembly 10 from the fully closed position (also referred to as primary latch position). In step 2100, the signal can be sent via key fob 91 or via first actuation device 40, by way of example and without limitation. The method 2000 further includes a step 2200 includes controlling power release to release latch assembly 10. Further, a step 2300 includes controlling cinch actuator 31 to control the speed of rotation of ratchet 16 to move toward a striker release position. The method 2000 further includes a step 2400 of returning (disabling) the cinch actuator 31 at a position before the secondary striker capture position.

The foregoing description of the embodiments has been provided for purposes of illustration and description. It is not intended to be exhaustive or to limit the disclosure. Individual elements, assemblies/subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A latch assembly (10) for a closure panel (12) of a motor vehicle (11), comprising:
a ratchet (16) configured for pivoting movement between a primary striker capture position, a secondary striker capture position, an intermediate striker capture position between the primary striker capture position and the secondary striker capture position, an over-travel position and an open position, wherein the ratchet (16) is biased by a ratchet biasing member (26) toward the open position;
a primary pawl (18) configured to hold the ratchet (16) in the primary striker capture position while in a primary ratchet holding position;
a secondary pawl (20) configured to hold the ratchet (16) in the secondary striker capture position while in a secondary ratchet holding position;
an intermediate pawl (22) configured to hold the ratchet (16) in the intermediate striker capture position while in an intermediate ratchet holding position; and
a cinch member (34) configured to move from a home position to an actuated position, whereupon the ratchet (16) is moved from the primary striker capture position to the over-travel position, whereat the primary pawl (18) disengages the ratchet (16) by moving from the primary ratchet holding position to a ratchet releasing position, and whereupon the cinch member (34) is returned to the home position, whereat the ratchet (18) is moved from the over-travel position to the intermediate striker capture position.

2. The latch assembly (10) of claim 1, wherein the primary pawl (18) is biased by a primary pawl spring member (36) to a neutral position, the primary pawl (18) being biased in a first direction away from the neutral position against the bias imparted by the primary pawl spring member (36) by the ratchet (16) when the ratchet (16) is in the primary striker capture position.

3. The latch assembly (10) of claim 2, wherein the primary pawl (18) is biased by the primary pawl spring member (36) to the neutral position when the ratchet (16) is moved to the over-travel position.

4. The latch assembly (10) of claim 3, wherein the primary pawl (18) is biased in a second direction opposite the first direction away from the neutral position against the bias imparted by the primary pawl spring member (36) by the ratchet (16) as the cinch member (34) is returned toward the home position.

5. The latch assembly (10) of claim 4, wherein the primary pawl (18) has a stop tab (64) biased by a stop tab spring member (68) to a stop position, the ratchet (16) engaging the stop tab (64) while moving from the primary striker capture position toward the intermediate striker capture position and causing the stop tab (64) to pivot against the bias of the stop tab spring member (68) to a release position, whereat the stop tab (64) disengages the ratchet (16), whereupon the primary pawl (18) returns to the neutral position under the bias imparted by the primary pawl spring member (36).

6. The latch assembly (10) of claim 4, wherein the primary pawl (18) is biased to the neutral position by the primary pawl spring member 36 when the ratchet (16) is in the intermediate striker capture position.

7. The latch assembly (10) of claim 6, wherein the ratchet (16) is urged to move from the intermediate striker capture position to the over-travel position by the cinch member (34) as the cinch member (34) moves from the home position to the actuated position, whereupon the ratchet (16) engages the primary pawl (18) and biases the primary pawl (18) in the first direction away from the neutral position against the bias imparted by the primary pawl spring member (36) to the ratchet hold position.

8. The latch assembly (10) of claim 1, wherein the rate of movement of the ratchet (16) from the over-travel position to the intermediate striker capture position is controlled by the rate of movement of the cinch member (34) from the actuated position to the home position.

9. The latch assembly (10) of claim 1, wherein the rate of movement of the ratchet (16) from the over-travel position to the intermediate striker capture position is controlled by bias of the ratchet biasing member (26).

10. The latch assembly (10) of claim 1, wherein the ratchet (16) cannot move to the open position directly from the intermediate striker holding position.

11. A method (1000, 2000) of releasing a latch assembly (10) to move a closure panel (12) from a closed position (14a) to a partially closed position (14d), comprising:
receiving a signal to release latch assembly (10) from the fully closed position;
actuating a cinch actuator (31) to move a cinch member (34) from a home position to an actuated position and causing a ratchet (16) to move to from a striker capture position to an over-travel position; and
causing the cinch actuator (31) to return the cinch member (34) to the home position, thereby causing the ratchet (16) to move toward a striker release position.

12. The method (1000, 2000) of claim 11, further including controlling the cinch actuator (31) to control the speed of rotation of the ratchet (16) toward the release position.

13. The method (1000, 2000) of claim 12, further including controlling the speed of rotation of the ratchet (16) toward the release position by controlling the speed of movement of the cinch member (34) from the actuation position to the home position.

14. The method (1000) of claim 11, further including controlling the speed of rotation of the ratchet (16) toward the release position via a ratchet biasing member (26).

15. The method (1000, 2000) of claim 11, further including causing the ratchet (16) to move to a one of an intermediate striker capture position and a secondary striker capture position, whereat the closure panel (12) is located in the partially closed position (14d), upon returning the cinch member (34) to the home position.

16. A latch assembly for a closure panel of a motor vehicle, comprising:
a ratchet configured for pivoting movement between a primary striker capture position, an over-travel position, an intermediate striker capture position, a secondary striker capture positon, and an open position, wherein the ratchet is biased by a ratchet biasing member toward the open position;
a primary pawl configured to hold the ratchet in the striker capture position while in a ratchet holding position and to allow the ratchet to move toward the open position while in a ratchet releasing position; and
a secondary pawl configured to hold the ratchet in the intermediate striker capture position while in an intermediate ratchet holding position and in the secondary striker capture position while in a secondary ratchet holding position,
wherein movement of the ratchet from the striker capture position to the over-travel position causes the primary pawl to move from the ratchet holding position to the ratchet releasing position.

17. The latch assembly of claim 16, further comprising a cinch member (34) configured to move from a home position to an actuated position to move the ratchet (16) from the primary striker capture position to the over-travel position, whereupon the primary pawl (18) disengages the ratchet (16) by moving from the ratchet holding position to the ratchet releasing position.

18. The latch assembly of claim 17, whereupon the cinch member (34) is configured to returned to the home position from the actuated position, whereat the ratchet (16) is moved from the over-travel position to the intermediate striker capture position.

19. The latch assembly of claim 18, wherein the rate of movement of the ratchet (16) from the over-travel position to the intermediate striker capture position is controlled by the rate of movement of the cinch member (34) from the actuated position to the home position.

20. The latch assembly of claim 18, wherein the ratchet (16) cannot move to the open position directly from the intermediate striker holding position.
